(19) United States
(12) Patent Application Publication
(10) Pub. No.: US 2012/0036637 A1
(43) Pub. Date: Feb. 16, 2012

(54) Rotating Bed to Reduce the Risk of Developing Pressure Ulcers

(76) Inventors: Hougong Wang, San Jose, CA (US); Zhendong Liu, San Jose, CA (US)

(21) Appl. No.: 12/855,949

(22) Filed: Aug. 13, 2010

(51) Int. Cl. A61G 7/005; A61G 7/008

(52) U.S. Cl. 5/608; 5/607

(57) ABSTRACT

Bed-bound patients are at risk for developing pressure ulcers after lying in the same position on a standard home/hospital bed for an extended period of time. In order to prevent pressure ulcers, patients' bodies need to be repositioned at certain time intervals by other personnel. This involves labor-intensive care, and the friction and shear forces during assisted turning often causes skin damage. The rotating bed enables bed-bound patients to reposition their body easily and frequently, thereby reducing external forces such as shearing forces and friction caused by assisted turning, and most importantly reducing the risk of developing pressure ulcers.

### FIELD OF THE INVENTION

Embodiments of the present invention generally pertain to the field of taking care of bed-bound patients. More specifically, embodiments of the invention relate to a rotating bed design to reduce the risk of developing pressure ulcers for the patients.

### BACKGROUND

Bed-bound patients are at risk for developing pressure ulcers after lying in the same position on a standard home/hospital bed for an extended period of time. In order to prevent pressure ulcers, patients' bodies need to be repositioned at certain time intervals by other personnel. This involves labor-intensive care, and the friction and shear forces during assisted turning often causes skin damage.

The prior art on this subject having two categories are listed below: The first category of the patents is to assist patients turning on a bed: U.S. Pat. Nos. 6,295,666, 4,843,665, 3,924,281, and 3,775,781. The second category of the patents is to have a rotation bed turning function around a pivot point rotating along a longitudinal axis: U.S. Pat. Nos. 4,586,492, 4,175,550, 4,071,916, 3,748,666, 3,739,406, 3,737,924, 3,434,165, 4,256,095 and 4,852,193.

This invention is to introduce a rotating bed, which can automatically turn the patient body side to side periodically with the desired rotation speed, angle, and functions, eliminating the need for assisted turning. In addition, the bed contact area can be changed to different contours to further reduce the risk of developing pressure ulcers. Moreover, the same rotation mechanism can be applied to assist the patient into a sitting position so that the bed-bound patient can have a more dynamic and comfortable environment.

### DESCRIPTION OF MANUFACTURING OF THE BED

As shown in FIGS. 1(a-e), a beam (1) spanning the length of the rotating bed connects two vertical beams (2), which each span the width of the bed. The length and width of the rotating bed are similar to a standard single bed. On each vertical beam, two bearing bases (3) are fastened on each side so that two small supporting wheels (4) can freely rotate. The larger head board wheel (5) and foot board wheel (6) sit on top of the smaller supporting wheels (4), and can be rotated either clockwise or counterclockwise along the rotation axis of A1. This is the main rotation mechanism that provides the side to side turning for the patient. A bed base (7) connects the head board (5) and the foot board (6), which enables a synchronized bed rotation. The head board wheel (5) is driven by a pulley (8), which is connected by a belt (9) to a second pulley (10), which is driven by a gear box and a motor (11). The motor is controlled and programmed so that the bed can be rotated at a desired angle, rotating speed, and frequency. The range of the bed rotation angle is from −90° (clockwise) to 90° (counterclockwise). The range of the bed rotation speed is from 0 to 12°/sec. It can be rotated in a continuous mode, or in a step function as shown in FIGS. 2(a) and (b). Other methods of building the bed and controlling the bed rotation for achieving the same results are within the scope of this invention.

On top of the bed base (7), a bed frame (12-14) can be rotated along the rotation axis A2, so that from the sleeping position (pin position P1 in the figure), the patient can be rotated to face either the right side (P2 pin position) or the left side (P3 pin position). In order to lift the patient's upper body into a sitting position and for ease of rotation to the left or right, the upper portion of the bed frame (12) can be rotated relative to the middle portion of the bed frame (13) along a rotation axis A3 from 180° (the current sleeping position) to 90° (the sitting position). This position can be adjusted by a pin (15) to a desired reclined position such as the one shown in FIG. 3 (about) 125°. The adjustment can be done manually or electronically. The same mechanism can be applied to lower the legs of the patient. Similarly, the bottom portion of the bed frame (14) can be rotated relative to the middle portion of the bed frame (13) along a rotation axis A4 from 0° (the current sleeping position) to −90° (the sitting position). This position can be adjusted by a pin (16) to a desired foot rest position, such as the one shown in FIG. 3 (about −45°). The adjustment can be done manually or electronically.

A series of rollers (17) are positioned on one side of the arm rest. The patient can be easily moved towards the headboard after the bed rotates 90° to let the patient rest on the rollers.

Other methods of rotating and controlling the bed recline and foot rest positions, and switching between sleeping and sitting positions to achieve the same results are within the scope of this invention.

Mattresses and foams serve as a buffer layer between the bed and patient. A series of belts and/or nets cover the patient's body to ensure safety during rotation and position changes. However, it should be noted that the mattresses/foams and safety belts/nets are not included in the drawings.

The bed cross sections can also be changed to a different contour. It can follow the patient's back contour as shown in FIGS. 4(a) and (b), or it can be a half tube as shown in FIGS. 5(a), and (b), or other cross sections as well.

When the half tube cross section is used, a slightly different mechanism will be used to reposition the patient from a sleeping to a sitting position. Two reclined plates (21, 22) need to be turned 90° around the pivotal points (23, 24) to join together and form the backrest, and the foot rest section (25) adjusted to a desired angle, as shown in FIG. 6.

### SUMMARY

The rotating bed enables bed-bound patients to reposition their body easily and frequently, thereby reducing external forces such as shearing forces and friction caused by assisted turning, and most importantly reducing the risk of developing pressure ulcers.

### BRIEF DESCRIPTION OF THE DRAWINGS

A more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1(a) is the primary view of the rotating bed in a sleeping position;

FIG. 1(b) is the top view of the rotating bed in a sleeping position;

FIG. 1(c) is the side view of the rotating bed in a sleeping position;

FIG. 1(d) is the cross section (A-A) view of the rotating bed;

FIG. 1(e) is the cross section (B-B or C-C) view of the rotating bed;

FIG. 2(a) is the rotating angle as a function of time in a continuous rotating mode;

FIG. 2 (b) is the rotating angle as a function of time in a step function rotating mode,

FIG. 3 is the cross section view of the rotating bed in a reclined position;

FIGS. 4(a) and (b) are the cross section (A-A) views of the rotating bed with different contour;

FIG. 5(a) is the top view of the rotating bed with a half tube cross section in a sleeping position;

FIG. 5(b) is the cross section (A-A) view of the rotating bed with a halt tube cross section;

FIG. 6 is the cross section view of the rotating bed with a half tube cross section in a reclined position;

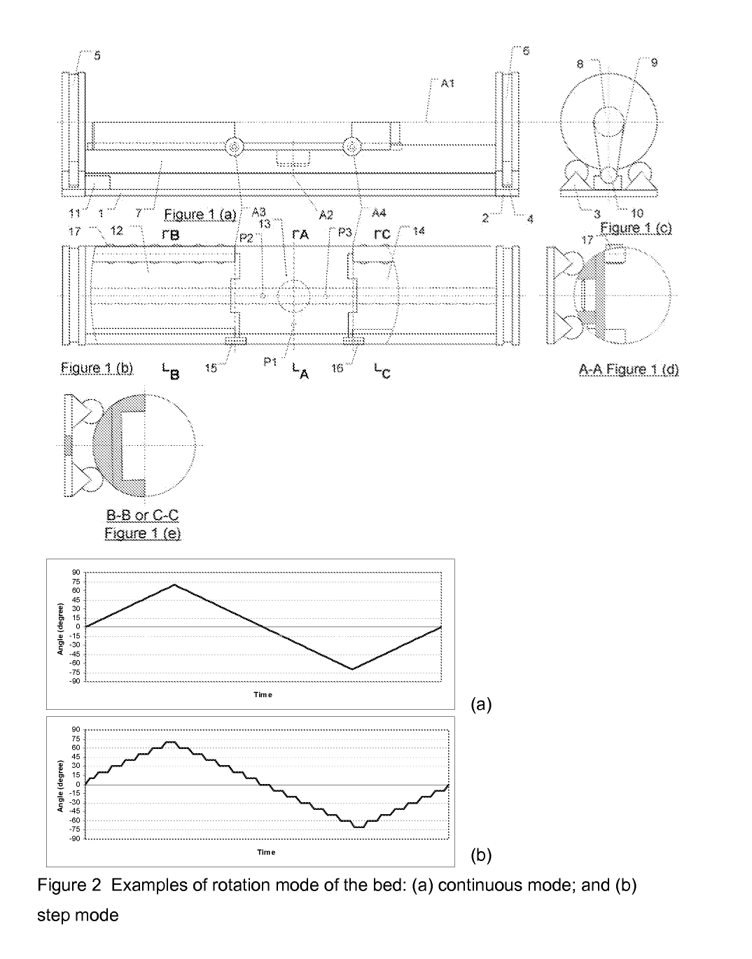

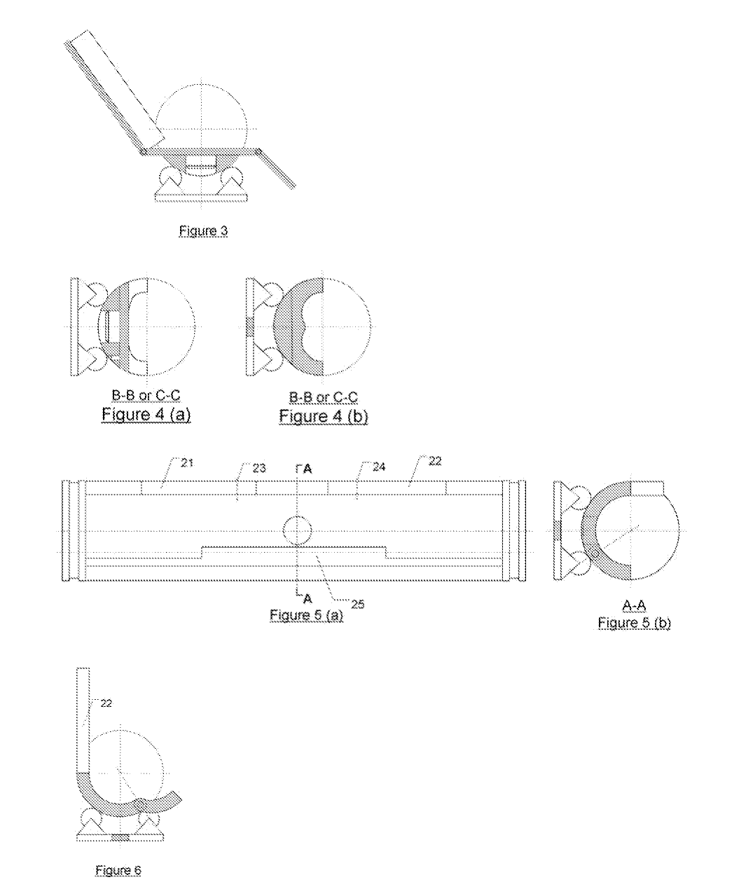

### DESCRIPTION OF USING THE BED

Before describing several exemplary embodiments of the invention, it is to be understood that the invention is not limited to the details of construction or functional steps set forth in the following description. The invention is capable of other embodiments and of being practiced or being carried out in various ways.

When a patient is sleeping on top of the bed portion 12-14, the bed can be rotated along the axis A1. Different functions can be programmed in, as shown in FIGS. 2(a) and (b). FIG. 2(a) is a continuous rotating function with a fixed rate of rotation speed between a maximum angle, and a fixed acceleration towards the maximum angle in either direction. FIG. 2(b) is a step function to achieve the same rotation angles. There are safety belts/nets along the patient body to secure the patient during rotation. The speed, acceleration, maximum angle and function can be adjusted to fit the patient's need, and can be programmed by a nursing assistant or the patient.

In the event that the patient's body slides down the bed, the patient can be repositioned by rotating the bed to the side. The patient, assisted by a nursing assistant, can then be pushed along rollers lining the side of the bed back into position and the bed rotated back to its original position.

When the patient wishes to sit up, the bed can be converted into a recliner. First, the upper portion of the bed can be adjusted relative to the middle portion so that the patient can be reclined at the desired position. The reclined upper portion can be adjusted from 90° (perfectly upright) to 180° (flat). Next, the bed can be rotated 90° along the axis A2 either to the left or right so that the patient is seated facing the left or right side depending on desire. Finally, the lower portion of the bed can be adjusted relative to the middle portion, so that the lower portion can be adjusted from 0° (flat) to −90° (straight down). Ideally, the upper portion should be close to 90° during this rotation to the left or right to reduce the space occupied by the bed. In addition, the main rotation mechanism can be applied to this reclined position as well to rock the patient back and forth in the same motion as a rocking chair.

The bed pocket can be changed to different contours at certain time intervals to avoid/reduce constant contact between certain body parts and the bed. Patients can also be switched to different beds with different contour arrangements to achieve the same effect.

When a half tube cross section is used, the bed can only be rotated in one direction in the reclined position along axis A2. The upper portion can only be set to the 90°, while the foot rest portion can be adjusted from about 90° to about −90°. All other functions are the same as the bed described above.

What is claimed is:

1. A bed frame with a headboard and footboard that together have a rotation mechanism that can rotate the patient side to side 90° to −90° along the longitudinal axis of the bed in a continuous mode or step mode.

2. The bed pocket in claim 1 has different contours to fit the patient's needs in a timely manner.

3. The bed in claim 1 has a sitting position that can use the same rotation mechanism to rotate along the same axis while the patient is in a sitting position, where the patient's body is perpendicular to the bed axis and can be rocked back and forth using this mechanism.

4. The bed in claim 3 has upper, middle and bottom portions of the bed frame, where the upper portion of the bed frame can be adjusted against the middle portion from 90° (sitting position) to 180° (sleeping position) or in between (recline positions), and the bottom portion of the bed frame can also be adjusted against the middle portion from 0° (sleeping position) to −90° (sitting position) or in between (recline positions).

5. The bed in claim 3 with a half tube cross section has a repositioned backrest on one side of the bed, and footrest (part of the half tube) on the other side of the bed, and the patient needs to be assisted to the sitting position substantially flat central region surrounded by a sloped region.
